(19) United States
(12) Patent Application Publication
(10) Pub. No.: US 2021/0139087 A1
(43) Pub. Date: May 13, 2021

(54) SYSTEM FOR ADJUSTING AN AIR DEFLECTION DEVICE IN A MOTOR VEHICLE

(71) Applicant: BITRON S.p.A., Torino (IT)

(72) Inventor: Fabrizio PROMUTICO, Alatri (Frosinone) (IT)

(73) Assignee: BITRON S.p.A., Torino (IT)

(21) Appl. No.: 17/095,165

(22) Filed: Nov. 11, 2020

(30) Foreign Application Priority Data
Nov. 13, 2019 (IT) 102019000021075

(51) Int. Cl. B62D 37/02; B62D 35/00

(52) U.S. Cl. CPC B62D 37/02; B62D 35/007

(57) ABSTRACT

A system for adjusting an air deflection device in a motor vehicle includes at least one first and at least one second adjustment devices for adjusting the attitude of the air deflection device, each adjustment device comprising a stationary part connected to the motor vehicle and a movable part force-transmittingly connected to the air deflection device, and at least one first and at least one second actuators, respectively associated with the at least one first and at least one second adjustment devices and actuatable independently of one another to respectively control the at least one first and at least one second adjustment devices.

### CROSS-REFERENCE TO RELATED APPLICATION

This application claims priority to and benefit of Italian Patent Application No. 102019000021075 filed Nov. 13, 2019, the contents of which are incorporated by reference in their entirety.

### FIELD OF THE INVENTION

The present invention relates in general to control systems for air deflection devices of motor vehicles, such as spoilers and other aerodynamic attachments on the bodywork of a motor vehicle.

### BACKGROUND OF THE INVENTION

With regard to spoilers, it is known to use central motorization systems in which the space for a transmission shaft that connects the actuator to the lateral kinematic mechanisms for moving the spoiler should be considered.

For bigger and more complex spoilers, which have a particular shape and are in particular arranged in the compartment where the motor or other obstructions are located, this may create problems or even create a situation of impossibility of use, because the space needed to allow the transmission shaft to pass between the actuator and kinematic mechanisms is not provided. In this regard, alternative pneumatic/oleodynamic solutions have been proposed, but these raise other problems in terms of the reliability of the air/oil circuit and its maintenance-free durability over time.

In some advanced applications, it may be required to modify the transverse inclination of the spoiler with respect to the car (according to a rotation of the car about axis x as conventionally indicated—i.e. parallel to the direction of travel of the car). Current systems make it difficult to implement this. Just one of the lateral kinematic mechanisms that control the spoiler could malfunction or jam, which is not easy to manage using conventional systems. A mechanical shaft system could lead to differentiated torsion of the shaft and irreversible system failure. An oleodynamic system may not be able to handle a single side of the spoiler becoming jammed, and would put the spoiler into an undesired mode inclined about axis x, with the potential for supports and parts of the bodywork to break.

Another disadvantage of conventional systems is that these systems are controlled by dedicated control units which are additional to the vehicle ECU of the car, with an increase in costs due to providing an additional component in the general control electronics of the vehicle. An additional control unit of this kind is necessary since the actuators have the sole function of actuating.

### SUMMARY OF THE INVENTION

One aim of the present invention is to provide a control system capable of at least partially overcoming the above-described disadvantages.

Therefore, the present invention provides a system for adjusting an air deflection device in a motor vehicle, comprising:
at least one first adjustment device and at least one second adjustment device for adjusting attitude of the air deflection device, each adjustment device of said at least one first and at least one second adjustment devices comprising a stationary part configured to be connected to the motor vehicle and a movable part force-transmittingly connected to the air deflection device, and
at least one first actuator and at least one second actuator respectively associated to said at least one first and at least one second adjustment devices and actuatable independently of one another to respectively control the movable part of the at least one first adjustment device and the movable part of the at least one second adjustment device.

In particular, the movable parts of said adjustment devices are connected to different points on the air deflection device.

Each adjustment device may comprise a mechanism selected from the group consisting of: wormscrew, rack, gears, articulated parallelogram, bars and combinations thereof.

According to a particular embodiment, the first adjustment device and the second adjustment device extend from a same stationary part.

The movable parts of the first and second adjustment devices may be connected to the stationary parts of the first and second adjustment devices, respectively, by respective kinematic chains separate from one another.

Each adjustment device may comprise at least one relevant sensor designed to provide a signal indicative of the dynamic state of the relevant adjustment device and/or of the relevant actuator.

Each adjustment device may comprise transmitting means for transmitting a signal indicative of the dynamic state of the relevant adjustment device and/or of the relevant actuator and receiving means for receiving a command signal for the relevant actuator.

The system according to the present invention may also comprise a control unit designed to operate said actuators on the basis of signals indicative of the dynamic conditions of the adjustment devices and/or of the actuators and/or of the motor vehicle.

Each actuator may be operated according to a predetermined relevant law of motion, said law of motion being defined by at least one of the following parameters: operating positions of the actuator and/or of the relevant adjustment device, speed of the actuator and/or of the relevant adjustment device, trajectory of the actuator and/or of the relevant adjustment device, and acceleration of the actuator and/or of the relevant adjustment device.

Said law of motion may be modified depending on the dynamic conditions of the relevant adjustment device and/or of the relevant actuator.

By means of the system according to the present invention, it is possible to establish a signal-only connection between the actuators via data transmission networks (for example CAN) without mechanical connections such as transmission shafts or pipes for oil or compressed air. It is possible to reduce the number of signals exchanged with the ECU of the vehicle by using an architecture that includes a master actuator and one or more slave actuators.

The use of independent adjustment devices together with the respective actuators makes it possible to achieve a high degree of control flexibility, as well as a high degree of adaptability to different vehicles and the possibility for simple adaptation to the vehicle configurations.

It is also possible to have control over the positions of the air deflection device in all conditions, thereby making it possible to prevent, identify and correct possible malfunctions caused by seizing or the like.

A further advantage is that of making it possible to modify the attitude of the car depending on the speed of the driving conditions of the car (for example when turning).

### BRIEF DESCRIPTION OF THE DRAWINGS

Further features and advantages of the present invention will become clear from the detailed description that follows, given purely by way of non-limiting example and with reference to the accompanying drawings, in which:

FIG. 1 is a schematic view of a system for adjusting an air deflection device in a vehicle according to the present invention;

FIG. 2 shows an example of a possible control architecture;

FIG. 3 is a perspective view of a movable spoiler of a vehicle and the relative adjustment system;

FIGS. 4 and 5 are perspective views of a power unit of the spoiler from FIG. 3;

FIG. 6 is a perspective view of the power unit from FIGS. 4 and 5, from which a cover cap has been removed;

FIG. 7 is a perspective view of a transmission mechanism of the unit in FIG. 4-6;

FIG. 8 is a perspective view of a power unit which may be used in an adjustment system according to the present invention;

FIGS. 9 and 10 are sectional views of the power unit from FIG. 8, in a retracted position and an extended position, respectively;

FIG. 11 is a perspective view of the internal components of the power unit from FIG. 8;

FIGS. 12 and 13 are, respectively, a side elevation view and a sectional view of some of the components from FIG. 11.

### DETAILED DESCRIPTION

FIG. 1 is a schematic view of an air deflection device, for example a rear spoiler of a motor vehicle. Typically, the air deflection device 10 comprises a body which may be moved with respect to the motor vehicle and comprises at least one surface designed to deflect air, while the vehicle is in motion, in order to achieve an aerodynamic effect.

FIG. 1 is also a schematic view of a system for adjusting the air deflection device 10. In the example, the system comprises a first and a second adjustment devices, 20, 30 for adjusting the attitude of the air deflection device 10. The first and second adjustment devices 20, 30 are connected to different points on the air deflection device 10. In the example, the first and second adjustment devices 20, 30 are arranged on opposite sides of the air deflection device 10. However, the number and arrangement of the adjustment devices may be different from those shown in the figure. For example, there may be two pairs of adjustment devices arranged on opposite sides of the air deflection device 10, wherein, in each pair, one adjustment device would be arranged further forward than the other.

Each adjustment device 20, 30 comprises a stationary part, 21 and 31 respectively, designed to be connected to the motor vehicle, which is indicated by reference sign V, and a movable part, 22 and 32 respectively, force-transmittingly connected to the air deflection device 10.

The system further comprises a first and a second actuators, 25, 35, respectively associated with the first and the second adjustment devices 20, 30, that may be operated independently of one another to respectively control the movable part 22 of the first adjustment device 20 and the movable part 32 of the second adjustment device 30. In other words, the movable part of one of the adjustment devices may be controlled directly by only the actuator associated with the particular adjustment device, and may optionally be controlled by the actuators associated with the other adjustment devices only indirectly by the air deflection device 10, because the movable parts of the adjustment devices are connected to one another only by the air deflection device 10.

In each adjustment device 20, 30, the relevant movable part 22, 32 is connected to the relevant stationary part 21, 31 via a kinematic chain. The kinematic chains of the adjustment devices 20, 30 are separate from one another. Each kinematic chain may comprise a mechanism such as: wormscrew, rack, gears, articulated parallelogram, bars and combinations thereof. Alternatively, in one or more of the adjustment devices 20, 30, the movable part and the stationary part may be directly connected to one another by the associated actuator. In an embodiment which is not shown, multiple adjustment devices may extend from a same stationary part.

In the example shown, each adjustment device 20, 30 is designed to bring about a linear movement of the relevant movable part 22, 32. Alternatively, the adjustment devices may be designed to bring about a rotational movement of the respective movable parts 22, 32, or to bring about a combination of movements. Moreover, the adjustment devices 20, 30 may be designed to bring about movements that are different from one another.

Each of the movable parts 22, 32 of the adjustment devices 20, 30 is connected to the air deflection device 10 by means of a constraint. The constraint may be of any type, including a fixed joint, a hinge, a link block, or another system known in the art. The constraint may be moved on any trajectory, i.e. in a straight line or so as to carry out a curve or a complex trajectory of any kind.

Thus, for example, if the movable parts 22, 32 are connected to the air deflection device by hinges, it is possible to create a configuration in which the air deflection device 10 may be rotated about the axis x of the vehicle.

The actuators 25, 35 associated with the adjustment devices 20, 30 may be linear or rotary.

Each adjustment device 20, 30 also comprises at least one relevant sensor 26, 36 designed to provide a signal indicative of the dynamic state of the relevant adjustment device 20, 30 and/or of the relevant actuator 25, 35.

The sensor 26, 36 may be an optical or magnetic encoder or another system known in the art.

Each adjustment device 20, 30 further comprises a relevant transmitter 27, 37 for transmitting a signal indicative of the dynamic state of the adjustment device 20, 30 and/or of the relevant actuator 25, 35, and a corresponding receiver 28, 38 for receiving a command signal for the relevant actuator 25, 35. The functions of receiving and transmitting may optionally be performed by a same device.

Each actuator 25, 35 may be provided with a data processing system, implemented for example on a printed circuit board (PCB), which data processing system makes it possible to monitor, over time, the position of the movable part of the actuator 25, 35 (linear position or angular position) and the force (or torque) exerted by the actuator, as well as electrical parameters absorbed by the motor of the actuator 25, 35 (voltage and current).

Each actuator 25, 35 may be provided with a data storage system (of the kind known in the art such as an EEPROM memory or another system) which makes it possible to store the set points, i.e. the desired states, of the actuator, or the positions or the expected forces developed by the actuator over time, as well as the electrical control parameters desired in these conditions. Similarly, the management logic for the actuator in various operating conditions may be stored.

According to one embodiment, the adjustment system may comprise n actuators which are coordinated with one another (where n is greater than or equal to 2).

Each actuator of a pair (or trio or element of a system comprising n actuators) may have stored a different law for opening or closing over time and its own law for applying the implemented load or a different mode of reacting to “disturbances” that may be received by the actuator.

The actuators may be connected to one another by a data exchange system of the kind known in the automotive field (for example a CAN network).

FIG. 2 shows a possible control architecture of the actuators, comprising a master actuator connected to the control unit (ECU) of the vehicle via a data connection system (for example a CAN line), and a plurality of slave actuators which interface with the control unit of the vehicle via the master actuator.

By means of these features of the actuator (integration of storage for operating data in the actuator, data processing and communication with other actuators) and this particular architecture (actuators that communicate with one another and using a master and slave structure in which only the master communicates with the vehicle ECU), it is possible to achieve a method for controlling a system (at least one pair) of actuators for the air deflection device 10 as indicated in the following.

1. The vehicle ECU communicates, to the master only, the set point to which the spoiler(s) should be brought and the manner in which this should be done. The set point may be the same or different for each of the individual actuators.
2. The master communicates its set point to be achieved to all of the slaves.
3. Each actuator controls itself in terms of position (linear or angular), force (torque) and in terms of diagnosis.
4. Each actuator communicates its state to the master.
5. The master verifies that the position and the force are consistent with an assigned law. In the simplest case, the law is that the actuators are synchronous in position. More complex laws may be defined, such as synchronous positions of the actuators at a particular actuation speed, or that at a certain time the position of the actuators should be defined (for example after a certain time the actuator has to have rotated by a certain angle). Even more complex laws may be defined, for example that there is a fixed delay in time or space between a pair of actuators, i.e. that the actuator has to move after a temporal or other offset. This makes it possible, for example, to have spoilers inclined about the axis x while the car is turning in order to recover the roll or about y in order to recover the pitching, or while braking as an aerodynamic brake.
6. The master communicates to the ECU if the state is as desired or not.
7. In the event of abnormal operation, the master is able to react autonomously from the ECU and have a differentiated failure communication threshold. For example, if the movement of one of the two actuators temporarily slows within a certain time or space margin, the master may wait for the actuator that has slowed, thus maintaining the synchronicity of the actuators in any case. Once a delay threshold is exceeded, the master may signal anomalies to the ECU that would otherwise not be communicated.

By means of the above-described method, a circuit is created for controlling the performance (position, force, failure) of n actuators for the active aerodynamics of a vehicle independently of the vehicle ECU, or which in any case exchanges a minimum number of items of information with the vehicle ECU (such as the steering angle or other vehicle parameters such as vehicle speed, and the set point to be reached for each actuator and the law of achievement).

However, different architectures are possible, for example an architecture in which the ECU of the vehicle communicates directly with all of the actuators and with the relative sensors.

FIGS. 3 to 7 show a rotary actuator which may be used in an adjustment system according to the present invention. In FIG. 3, however, the rotary actuator is used in a conventional configuration, in which the adjustment system of the air deflection device provides the actuator positioned centrally with respect to the air deflection device 10 and connected to a pair of kinematic mechanisms 100 arranged on opposite sides of the air deflection device 10.

In FIGS. 3-7, the rotary actuator is in the form of a gearmotor unit, indicated as a whole by reference sign 250. The housing of the gearmotor unit 250 may be fixed to the structure of the vehicle, and therefore form the stationary part of one of the adjustment devices of the system described above.

This gearmotor unit 250 has a highly compact and lightweight construction, minimal noise production, and is capable of making the air deflection device 10 assume different operating positions without the use of additional positioning elements.

The gearmotor unit 250 substantially comprises:
a controllable electric motor which has an output shaft,
a reduction gear mechanism comprising a helical bevel gear and a worm gear, the helical bevel gear being coupled to the output shaft of the electric motor by a conical sprocket, the helical bevel gear having a mating bevel gear designed to be operatively connected to a wormscrew of the worm gear, the worm gear having a mating gear designed to drive an adjustment shaft of the air deflection device; and
a mechanical drive force transmitter designed to transmit a drive force to the air deflection device.

FIG. 3 shows the air deflection device 10, and in particular a spoiler movable in a plurality of desired positions with respect to a motor vehicle, more precisely a rear spoiler which may be arranged in the rear part of the vehicle. The air deflection device 10 is adjustable between at least one operating position, in which the air deflection device is extended with respect to the profile of the bodywork of the vehicle in a raised position, and a rest position, in which it is retracted into a position in which its profile roughly matches the profile of the bodywork or into a position which has little or no influence on the air flow. The adjustment movement is obtained by means of the gearmotor unit 250. The gearmotor unit 250 comprises an electric motor 259 and a reduction mechanism which interacts with the electric motor. The reduction mechanism acts on a drive shaft 253 which interacts with the kinematic mechanisms 100 in order to mechanically transmit the drive force which originates from the gearmotor unit 250 to the air deflection device 10.

FIG. 7 is a detailed view of the motor together with the reduction mechanism. A conical sprocket 255 of a helical bevel gear A is driven by the output shaft 254 of the electric motor 259. The conical sprocket 255 interacts with a mating bevel gear 256 which drives the wormscrew 257 of a worm gear B. The wormscrew 257 acts on a mating gear 258, by means of which the adjustment shaft 253 is driven directly or indirectly. In the example shown, the gear 258 drives a cylindrical sprocket 261, which interacts with a cylindrical gear 262 that drives a reduction gear output shaft 263. The adjustment shaft 253 is coaxially fixed at one end of the reduction gear output shaft 263, or the adjustment shafts 253 are respectively coaxially fixed at both ends if the gearmotor unit is positioned centrally with respect to the air deflection device 10. In the gearmotor unit described above, it is possible to achieve high reduction ratios which make it possible to achieve a self-locking feature which keeps the air deflection device in any desired operating position without additional positioning or locking means, even at high speeds of the vehicle or under increased wind pressure; moreover, the unit described above is relatively noiseless.

FIG. 6 shows the gearmotor unit 250, from which a cover cap has been removed which is indicated by reference sign 264 in FIGS. 4 and 5. As may be seen in FIG. 6, the electric motor 259 is associated with a printed circuit board 265 on which, as described above, at least one sensor may be arranged which is designed to provide a signal indicative of the dynamic state of the electric motor 259, the sensor being in the form of an optical or magnetic encoder or another system known in the art. A transmitter and a receiver may be arranged on the board 265. The transmitter and receiver are intended for transmitting a signal indicative of the dynamic state of the actuator 259 and for receiving a command signal for the actuator 259, respectively. A data processing system may be provided on the board 265. The data processing system makes it possible to monitor, over time, the angular position of the output shaft 254 of the motor 259 and the torque exerted by the motor, as well as electrical parameters absorbed by the motor (voltage and current). A data storage system may also be provided on the board 259. The data storage system makes it possible to store the set points, i.e. the desired states, of the actuator, or the positions or the expected forces developed by the actuator over time, as well as the electrical control parameters desired in these conditions. Similarly, the management logic for the actuator in various operating conditions may be stored.

FIGS. 8 to 13 show a linear actuator which may be used in an adjustment system according to the present invention.

In FIGS. 8-13, the linear actuator is in the form of a power unit, indicated as a whole by reference sign 350. The housing of the power unit 350 may be fixed to the structure of the vehicle, thereby forming the stationary part of one of the adjustment devices of the system described above with reference to FIG. 1.

The power unit 350 has a highly compact and lightweight construction, minimal noise production, and is capable of making the air deflection device 10 assume different operating positions without the use of additional positioning elements.

The gearmotor unit 250 substantially comprises a controllable electric motor which has an output shaft, and a transmission mechanism connected to the output shaft that transforms the rotary motion generated by the electric motor into the linear motion of a rod. The rod is then connected directly, or indirectly via a kinematic chain, to the air deflection device 10.

FIGS. 11-13 show a detailed view of the motor together with the transmission mechanism, which are arranged inside the housing of the power unit 350 shown in FIGS. 8 to 10.

In the example shown, the transmission mechanism comprises a gear train C formed by a plurality of cylindrical gears, the first of which is driven directly by the output shaft 351 of the electric motor 352. The cylindrical gears are indicated by reference signs 353, 354, 355 and 356, and are designed so as to produce a particular reduction ratio between the angular velocity of the output gear, indicated by 356, and the input gear, indicated by 353, which is mounted on the output shaft 351 of the electric motor 352. A wormscrew 358 of a screw-nut screw coupling D is arranged coaxially on a shaft 357 of the output gear 356. The wormscrew 358 interacts with a nut screw element 359 in order to bring about a linear movement of the nut screw element 359.

The rod 361 is fixed to the nut screw element 359, the rod being slidably mounted in the housing of the power unit 350 and designed to be connected, directly or indirectly, to the air deflection device 10. In the example shown, the distal end of the rod 361 is provided with a ball joint 362 which allows the element connected thereto to modify its inclination with respect to the rod 361.

As may be seen in FIGS. 11-13, the electric motor 352 is associated with a printed circuit board 365 on which, as described above, at least one sensor may be arranged which is designed to provide a signal that is indicative of the dynamic state of the electric motor 352. In particular, a specific sensor will be described in the following with reference to FIGS. 12 and 13. A transmitter and a receiver may also be arranged on the board 365, the transmitter and receiver being intended for transmitting a signal indicative of the dynamic state of the actuator 352 and for receiving a command signal for the actuator 352, respectively. A data processing system may be provided on the board 365. The data processing system makes it possible to monitor, over time, the angular position of the output shaft 351 of the motor 352 and the torque exerted by the motor, as well as electrical parameters absorbed by the motor (voltage and current). A data storage system may also be provided on the board 365. The data storage system makes it possible to store the set points, i.e. the desired states, of the actuator, or the positions or the expected forces developed by the actuator over time, as well as the electrical control parameters desired in these conditions. Similarly, the management logic for the actuator in various operating conditions may be stored.

With reference to FIGS. 12 and 13, a magnetic sensor, for example a Hall-effect sensor, is arranged on the shaft 357 of the output gear 356, the magnetic sensor being designed to provide a signal indicative of the angular velocity of the shaft 357 of the gear 356. Reference sign 366 indicates a transducer of the magnetic sensor. The shaft 357 is associated with a reduction mechanism E comprising a gear train formed by a plurality of cylindrical gears, indicated by reference signs 367, 368, 369 and 370. The gear train comprises a bushing 367a which is fixed coaxially to the shaft 357 and on which an external toothing (input gear) 367 is formed. The external toothing 367 interacts with the gear 368, which in turn drives the gear 369. The gear 369 in turns interacts with the detection gear 370, which is mounted coaxially on the bushing 367a and is rotatable relative thereto. A permanent magnet 371 is arranged on the detection gear 370, which permanent magnet acts as a movable part to be detected by the transducer 366.

According to alternative embodiments, instead of the magnetic sensor, a different type of contactless sensor, such as an optical sensor, or a contact sensor, such as a microswitch, may be provided.

What is claimed is:

1. A system for adjusting an air deflection device in a motor vehicle, the system comprising:
at least one first adjustment device and at least one second adjustment device for adjusting attitude of the air deflection device, each adjustment device of said at least one first and at least one second adjustment devices comprising a stationary part configured to be connected to the motor vehicle and a movable part force-transmittingly connected to the air deflection device, and
at least one first actuator and at least one second actuator respectively associated to said at least one first and at least one second adjustment devices and actuatable independently of one another to respectively control the movable part of the at least one first adjustment device and the movable part of the at least one second adjustment device.

2. The system of claim 1, wherein the movable parts of said at least one first and at least one second adjustment devices are connected to different points of the air deflection device.

3. The system of claim 1, wherein each adjustment device of said at least one first and at least one second adjustment devices comprises a mechanism selected from the group consisting of: endless screw, rack and pinion, geared wheels, articulated quadrilateral, rods and combinations thereof.

4. The system of claim 1, wherein the at least one first adjustment device and the at least one second adjustment device extend from a same stationary part.

5. The system of claim 1, wherein the movable parts of the at least one first and at least one second adjustment devices are connected to the stationary parts of the at least one first and at least one second adjustment devices, respectively, through respective kinematic chains separate from each other.

6. The system of claim 1, wherein each adjustment device of said at least one first and at least one second adjustment devices comprises at least one respective sensor configured to provide a signal indicative of a dynamic condition of a respective adjustment device and/or respective actuator.

7. The system of claim 6, wherein each adjustment device comprises transmitting means for transmitting a signal indicative of a dynamic condition of the respective adjustment device and/or respective actuator and receiving means for receiving a control signal for the respective actuator.

8. The system of claim 1, further comprising a control unit configured to actuate said at least one first and at least one second actuators based on signals indicative of dynamic conditions of the at least one first and at least one second adjustment devices and/or actuators and/or motor vehicle.

9. The system of claim 1, wherein each actuator is actuatable according to a respective, predetermined motion law, said predetermined motion law being defined by at least one of the following parameters: operating positions of the actuator and/or respective adjustment device, speed of the actuator and/or respective adjustment device, trajectory of the actuator and/or respective adjustment device, and acceleration of the actuator and/or respective adjustment device.

10. The system of claim 9, wherein said predetermined motion law is changeable as a function of the dynamic conditions of the respective adjustment device and/or respective actuator.
